(19) United States
(12) Patent Application Publication
(10) Pub. No.: US 2025/0198082 A1
(43) Pub. Date: Jun. 19, 2025

(54) PULPER FOR PRODUCING A STOCK SUSPENSION FROM SOLID PARTICLES AND A FLOWABLE MEDIUM

(71) Applicant: W. LANGE GMBH ENGINEERING & SCREENING COMPONENTS, Nattheim (DE)

(72) Inventor: Werner LANGE, Nattheim (DE)

(21) Appl. No.: 18/715,979

(22) PCT Filed: Oct. 21, 2022
(86) PCT No.: PCT/EP2022/079341

§ 371 Date: Dec. 9, 2024

(30) Foreign Application Priority Data
Oct. 21, 2021 (DE) 10 2021 211 856.9

(51) Int. Cl. D21B 1/34

(52) U.S. Cl. CPC D21B 1/345

(57) ABSTRACT

A pulper for producing a pulp suspension from paper, solids and water, including a cylindrical container for holding a main part of the pulp suspension and having a container wall and a container bottom, and a rotor arranged in an interior of the container for disintegrating the pulp fed into the container and for producing an aqueous suspension. The container wall has, as seen in plan view and/or in a horizontal section, the shape of a triangle with rounded corner regions, at least one of the corner regions is configured such that a flow deflection of less than 90° occurs during operation, the container wall between two corner areas is flat or curved with a radius of curvature that is greater than that of the two corner regions, and the pulper is free of additional containers located outside of the container.

The invention relates to a pulper for producing a pulp suspension, in particular from paper or waste paper or paper waste or other fibrous materials and water. See the generic term of claim 1.

Pulpers of this kind have been known for a long time. They are used in particular in paper mills. The fibrous waste materials used in this process may, for example, be paper waste from the paper processing industry in sheet form, but also waste paper in the form of bales. The pulp suspension produced by a pulper according to the generic terms of claim 1 is used to produce new paper or cardboard, usually after further mechanical treatment or cleaning of the fibers contained in the suspension.

The mechanical pulping process in the pulper must fulfill two essential conditions:
The pulping process must be carried out with the utmost perfection so that the solid materials fed into the container are broken down into fibers. The suspension must therefore be free of fiber bundles, with the individual fibers separated. The finished suspension must look like a milky, cloudy liquid when observed in a test tube.
The total energy required to achieve the above result should be minimal, which is of the utmost importance in today's world.

There are numerous pulper designs. See for example the following publications:
DE 100 46 160 A1
DE 295 00 801 U1
DE 290 357 A
AT 372 992 B
CH 374 972 A
FR 1 205 637 A
U.S. Pat. No. 4,941,752 A
EP 0 898 012 A1.

The pulpers described in these patents are in need of improvement in a number of ways. One shortcoming is the imperfect pulping action. Even after a pulper has been in operation for some time, fiber bundles remain that appear as so-called specks when new paper is being produced. The pulping efficiency is insufficient because the pulping process does not lead to the desired result even after a long period of treatment in the pulper. Finally, the structural effort is very high in many cases, which means high investment costs.

The object of the invention is to provide a pulper that accomplishes the problem mentioned at the beginning. This is achieved by the following essential features:
the container wall that comes into contact with the material during operation is triangular with rounded corner areas, as seen in a plan view or in a horizontal section;
the ratio between the maximum diameter of the container and the radius of curvature of the rounded corner areas is between 2 and 10, for example 2, 3, 4, 5, 6, 7, 8, 9 or more;
at least one of the corner areas is designed in such a way that the medium flowing around it experiences a deflection of less than 90°.

The solution according to the invention results in perfect dissolution of fibrous suspensions, with a minimal energy input. The energy behavior of two pulpers was examined, namely a conventional pulper V20, comprising a cylindrical container with a circular cross-section, and a pulper “TRIPLEX” according to the invention, with a container of triangular cross-section.

In both experiments, all process parameters were the same, only the containers were different, as mentioned above:
the input for both experiments consisted of the same material, namely waste from paper processing in the form of paper strips of the same quality in bales,
a certain amount of water,
a rotor of the same design, arranged in the bottom of the container.

The pulping process was the same for both trials. The aim was to produce a paper pulp suspension, which consisted of individual fibers and water, and which, when viewed in a test tube, looked like a milky, cloudy liquid, without any fiber bundles, which appear in the finished paper web as so-called specks and are highly undesirable for the paper maker.

The only difference in the pulping process was the length of time the material was treated in the pulper: the time taken to achieve a usable suspension was significantly shorter when using the pulper according to the invention than when using the conventional pulper. The conventional pulper required about 20% more time and thus also 20% more energy, measured in kWh, to produce a paper stock suspension that was usable by the paper maker. The inventor has identified the following processes as the reason for the advantage of the TRIPLEX pulper according to the invention:
With the container shape of a triangle with (significantly) rounded corners, as in the invention, the following flow pattern occurs with a circulating rotor and with a suspension in the process of being created: As in any pulper vessel, the suspension undergoes a gyratory motion around the rotor's axis of rotation, and in this case also around the vertical longitudinal axis of the vessel. Just before each rounded corner area, the flow is decelerated, but in the exiting corner area, the flow is accelerated again. The acceleration also affects the solid particles of the resulting suspension, causing them to be carried along and thus torn apart. In the case of fiber bundles or fiber lumps, individual fibers are separated from such bundles.

This is precisely the desired effect. After the rotor has been running for a certain period of time, all fiber bundles or fiber lumps have been broken down into individual fibers. The suspension is in a state that allows it to be used as intended, namely directly or indirectly for what is known as sheet formation, i.e. the formation of a paper web in the headbox of a paper machine.

It is recommended that the container wall be kept as smooth as possible. Another advantage of the invention is that the wear on the container wall is low, in particular lower than in the case of a design with ribs or trip hazards or other protrusions that extend into the container interior, which, however, should not be ruled out. The example shows how amazing results can be achieved from a “used product”, namely from a pulper that has been in use for decades.

The invention is explained in more detail in the drawing. The following is shown in detail:

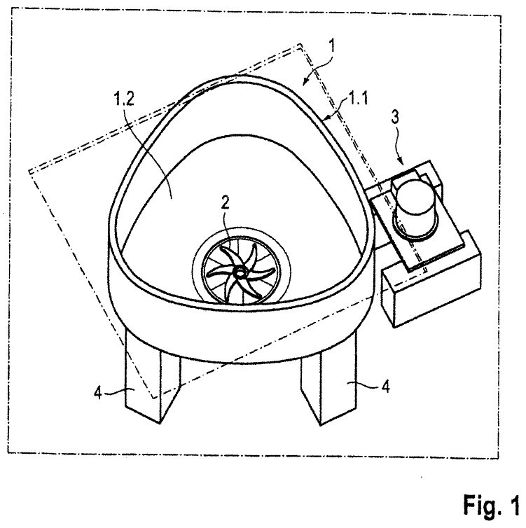

FIG. 1 shows a perspective view of a pulper according to the invention.

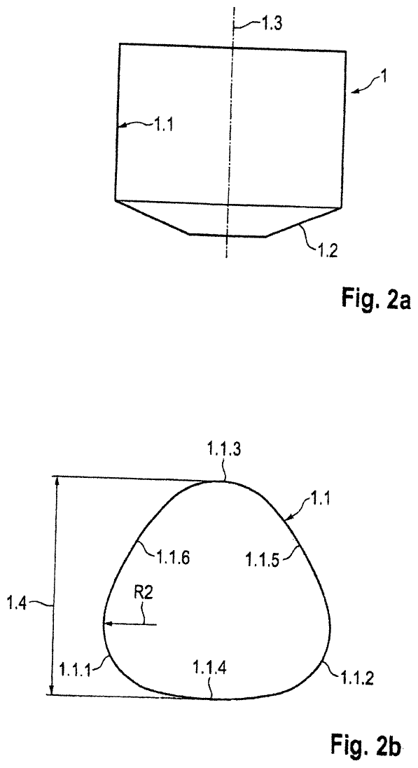

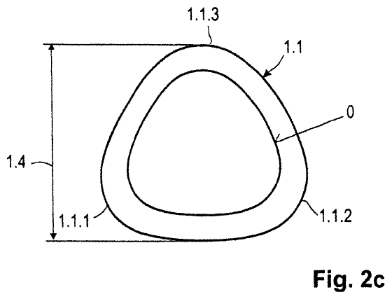

FIG. 2a shows the container of the pulper according to the invention in elevation.

FIG. 2b shows the container according to FIG. 2a in a plan view.

FIG. 2c shows a container of a pulper analogous to that according to FIGS. 2a and 2b, but with a container that tapers upwards.

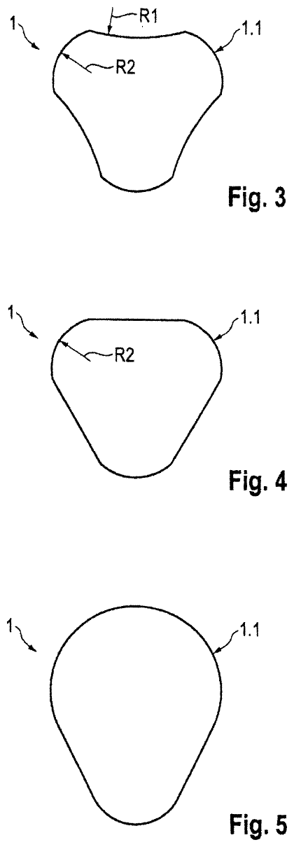

FIG. 3 shows the container of a pulper according to the invention with a convex wall area between two corner areas.

FIG. 4 shows the container of a pulper according to the invention with straight partition walls.

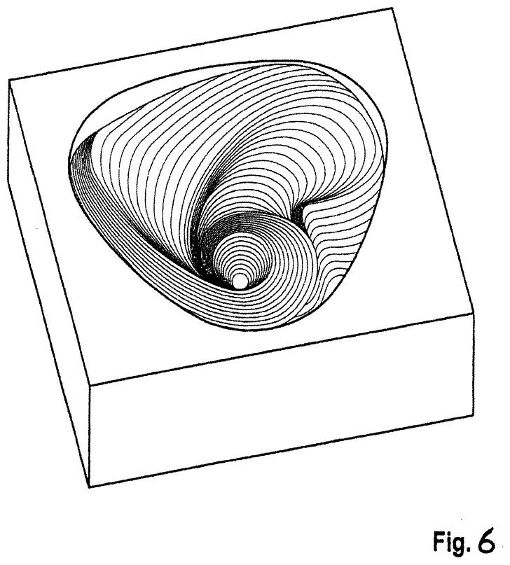

FIG. 5 shows the container of a pulper according to the invention, again in a plan view of its pear-shaped container.

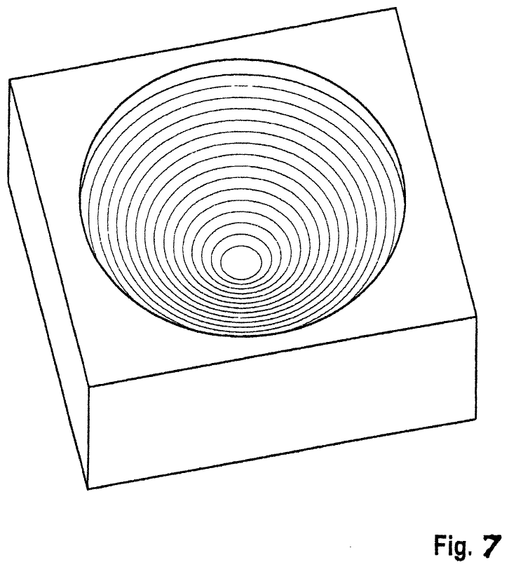

FIG. 6 is a perspective view of a pulper according to the invention during operation.

FIG. 7 is a conventional pulper V20 in perspective during operation.

The pulper shown in FIG. 1 comprises a container 1 with a container wall 1.1 and a container bottom 1.2. Container 1 is essentially triangular in plan view and thus also in an axially perpendicular cross-section.

A rotor 2 is provided at the bottom 1.2 of the container 1. In the present case, the blades are curved in the manner of a pump impeller against the direction of rotation. The direction of rotation is thus clockwise.

The rotor 2 is driven by a motor 3. The container 1 rests on vertical supports 4.

FIGS. 2a to 4 illustrate various shapes of the container wall 1.1. FIG. 2a shows the container wall 1.1 and the container bottom 1.2. The container bottom is frustoconical. The rotor 2 is not shown in this illustration. The rotational axis of the container coincides with the longitudinal axis 1.3 of the rotor.

As can be seen from FIG. 2b, the container wall 1.1 consists of three corner sections 1.1.1, 1.1.2, 1.1.3, as well as partition walls 1.1.4, 1.1.5, 1.1.6 located in between. The areas mentioned are circular arcs. However, they could also consist of other geometrically curved elements. The angle a between two partition walls 1.1.4 and 1.1.5 is always smaller than 90°, for example 20 to 80° or 30 to 45°. This applies in general.

FIG. 2c shows the container 1 of a pulper analogous to that according to FIGS. 2a and 2b. However, its container tapers continuously from bottom to top. See the upper edge 0 of the container. FIG. 3 shows that the partition walls 1.1.4, 1.1.5 and 1.1.6 are convex when viewed from the outside. In the embodiment according to FIG. 4, the partition walls 1.1.4, 1.1.5 and 1.1.6 are straight.

In the embodiment according to FIG. 5, the wall of container 1 comprises a corner region 1.1.1 which, according to the invention, is pear-shaped. This corner region is formed from a smaller circular shell and an opposing larger circular shell. The two circular shells are connected to each other by straight partition walls.

In the pear-shaped design of FIG. 5, the container wall forms only a single corner area, which, according to the invention, is designed in such a way that the individual particles are separated, as mentioned above. This is achieved by the temporarily increased flow velocity as the particles exit the corner area, which causes individual cohesive particles, such as individual fibers from a fiber bundle, to be torn apart.

FIGS. 6 and 7 show the flow pattern-FIG. 6 that of the pulper according to the invention, TRIPLEX, and FIG. 7 that of the known pulper V20. FIG. 6 shows the effect of the three rounded corner areas on the flow. In FIG. 7, one can see that the flow circulates without any disturbance. This means that there is no intentional deceleration or acceleration, and thus no effect on the particles contained in the flow, and therefore no separation of the particles.

In all the embodiments described, the corner regions each form an angle a that is smaller than 90°.

The triangular shape of the container wall is preferably an isosceles triangle. However, it can also be an equilateral triangle or a triangle with three sides of different lengths.

### LIST OF REFERENCE SIGNS

1. Container
1.1 Container wall
1.1.1 Corner area
1.1.2 Corner area
1.1.3 Corner area
1.1.4 partition walls
1.1.5 partition walls
1.1.6 partition walls
1.2 container floor
1.3 longitudinal axis of the container and axis of
rotation of the rotor
1.4 maximum diameter of the container
2 rotor
3 motor
4 supports
O upper edge of the container
a angle in the corner areas

1. A pulper for producing a pulp suspension from paper or waste paper or paper waste or other solid materials and water, comprising:
a cylindrical container for holding a major part of the pulp suspension, having a container wall and a container bottom; and
a rotor arranged in an interior of the container for disintegrating the pulp fed into the container and for producing an aqueous suspension;
wherein:
the container wall has, as seen in plan view and/or in a horizontal section, a shape of a triangle with rounded corner regions;
at least one of the corner regions is configured such that, in operation, a flow deflection of less than 90° is effected;
the container wall between two corner regions is flat or curved with a radius of curvature that is greater than that of the two corner regions; and
the pulper is free of additional containers located outside the container.

2. The pulper according to claim 1, wherein a ratio between a maximum diameter of the container and a radius of curvature of a corner region is between 2 and 10.

3. The pulper according to claim 1, wherein an axis of rotation of the rotor is mounted in the container bottom and runs parallel to a longitudinal axis of the container or coincides with the longitudinal axis.

4. The pulper according to claim 1, wherein a surface of the container wall that comes into contact with material during operation has a continuous, edgeless configuration.

5. The pulper according to claim 1, wherein the container wall is assembled from three shells, which form the rounded corner regions, and three partition walls which each connect two rounded corner regions to one another.

6. The pulper according to claim 1, wherein a ratio between a radius of curvature of a concave or convex partition wall and a radius of curvature of a corner region is between 1 and 3.

7. A pulper for producing a pulp suspension from paper or waste paper or paper waste or other fibrous materials and water, comprising:
a cylindrical container having a container wall and a container bottom; and
a rotor arranged in an interior of the container for disintegrating the pulp fed into the container and for producing an aqueous suspension;
wherein:
the container wall is round, when seen in plan view or in a horizontal section, with one or two rounded corner regions; and
a ratio between a maximum diameter of the container and a radius of curvature of a corner region is between 1 and 10 or a value lying in between.

8. The pulper according to claim 1, wherein the container tapers from bottom to top up to an upper edge.

9. The pulper according to one claim 1, further comprising a control device, the control device, during operation, being configured to determine parameters of the pulp suspension circulating in the container or the pulping state of the pulp and, on the basis of the determined parameters, controls the drive power of the rotor for minimizing energy input.
